(19) United States
(12) Patent Application Publication
(10) Pub. No.: US 2010/0175288 A1
(43) Pub. Date: Jul. 15, 2010

(54) Antenna ball assembly and method of use

(76) Inventor: Dennis D. Engler, Plainfield, IL (US)

Correspondence Address: Breiner & Breiner, L.L.C., P.O. Box 320160, Alexandria, VA, 22320-0160, US

(21) Appl. No.: 12/654,952

(22) Filed: Jan. 11, 2010

Related U.S. Application Data
(60) Provisional application No. 61/193,940, filed on Jan. 12, 2009.

(51) Int. Cl. G09F 21/04

(52) U.S. Cl. 40/591; 116/209

(57) ABSTRACT

An antenna ball assembly which can display a design or the like thereon and a method of use is disclosed. The antenna ball assembly has a body having a passage therethrough, a rearward projecting member and at least one flexible stopper. A flexible stopper is preferably positioned at each of the bottom and the top of an antenna. The body is positioned between the stoppers on the antenna with the antenna passing through the passage in the body. The rearward projecting member has a free end and is of a predetermined length with an extended width over at least a portion of the length, wherein the extended width is greater than the width of the antenna ball body. The rearward projecting member forms an angle of preferably from about 20° to less than 50° with the vertical axis of the passage through the body. The angled rearward projecting member controls the movement of the body, thereby allowing the body to move up the antenna as the antenna moves, such as when attached to a car.

### RELATED APPLICATION

This application claims the benefit of U.S. Provisional Application No. 61/193,940 filed Jan. 12, 2009.

### FIELD OF INVENTION

The present invention relates to an antenna ball assembly with a body and a rearward projecting member which may display a design, advertisement or the like thereon, and a method of use thereof. The antenna ball assembly preferably is positioned on an antenna such that the antenna ball body moves up and down the antenna based on motion of the antenna.

### BACKGROUND OF THE INVENTION

People enjoy having novelty items on their vehicles, such as on the vehicle antenna. These novelty items tend to have colorful designs, animations, slogans or advertisements thereon. Thus, the items may be purely fanciful or whimsical, or serve multiple purposes.

In addition, people can use various modes of advertisement, including on novelty items on a vehicle, for promoting their business or sponsored activities. Traditional forms of advertising include word-of-mouth, placing an advertisement in a newspaper, placing an advertisement in a magazine and/or placing an advertisement on a billboard. However, traditional modes of advertising may not reach as broad of a group of people as desired or a particular targeted group of people by the person placing the advertisement. As such, people are developing new modes of advertising to reach a broad or targeted audience which requires less effort on the part of the audience to view the advertisement.

Further, novelty items and the like may be used to show support of a sporting team, school, or the like, streamers of representative colors or pennants with names as desired may be flown on a vehicle, in particular as the vehicle proceeds to an event for the team, school or the like.

U.S. Pat. No. 7,093,385 B2 discloses an antenna ball assembly having a body with at least one inclined surface and a passage therethrough, a tail attached to the body and at least one flexible stopper. The at least one inclined surface is preferably two inclined body extension members or an inclined flat face. The angle of the at least one inclined surface controls the movement of the body up the antenna and the tail keeps the antenna ball body straight and facing into the wind.

The present invention provides a new and interesting display means which provides a different look from known antenna display elements and is less costly to manufacture.

### SUMMARY OF THE INVENTION

The present invention relates to an antenna ball assembly which is displayed on an antenna and a method of use. The antenna ball assembly may optionally include a design, advertisement, streamer or the like thereon or depict a character or object. The antenna ball assembly preferably is positioned on an antenna such that an antenna ball body moves up and down the antenna as the antenna moves, thereby displaying the antenna ball itself or the design, advertisement or the like thereon. The assembly may be used with an antenna or rod-like member attached to any article capable of sustained motion, e.g., a car, truck, motorcycle, bike, or other vehicle. For convenience of discussion the invention will be described in relation to use with a car antenna.

The antenna ball assembly preferably comprises an antenna ball body having a passage extending therethrough, a rearward projecting member, and at least one flexible stopper. The antenna ball body is placed on the antenna with the antenna passing through the passage therein. A flexible stopper is then placed on the car antenna to keep the antenna ball body from coming off of the car antenna when in use. Another flexible stopper may be positioned at the bottom of the car antenna to provide a base for the ball so that the ball body does not get stuck on the bottom of the antenna since some antennas have a tapered end or base that could inadvertently get wedged into or against the passage in the ball body making it difficult or preventing the ball body from moving upward on the antenna. Thus, the lower flexible stopper serves to decrease the amount of motion required before movement of the body along the antenna. Additionally, the flexible stoppers can be positioned on the antenna a shortened distance apart to provide limited or restricted motion of the ball body, for example a ball body with a flag attached and positioning the stoppers and, thus, the ball to be a flag at half mast. The stoppers can be positioned at any location on the antenna based on the desires of the user.

The antenna ball body is preferably spherical or substantially spherical in shape. However, the antenna ball body may be any other suitable shape which allows the wind to move around the body in an aerodynamic manner, such as, but not limited to, oblong-shaped, blimp-shaped, egg-shaped, or the like.

The rearward projecting member includes a length and an extended width at least along a portion of the length to combine functions previously provided by two structures, i.e., an inclined surface and a tail. The rearward projecting member is preferably angled in relation to the antenna ball body such that the angle measured between the rearward projecting member and the passage extending through the antenna ball body is less than 50°, preferably from about 20° to about 45°, more preferably from about 25° to about 40°, and most preferably from about 30° to about 35°. This angle serves to control the movement of the antenna ball body. The angle serves to provide lift to the antenna ball body causing it to move or fly up the car antenna as the car with the antenna moves. The rearward projecting member is preferably downwardly inclined to provide for the most efficient and optimum lift, but may be substantially horizontal with no or minimal incline, or may be upwardly inclined.

The size, shape and/or length of the rearward projecting member is arranged so that the rearward projecting member acts to keep the antenna ball body straight and facing into the wind while providing lift to the antenna ball body. The rearward projecting member, along with the antenna ball body, may serve as a space for a design or message to be printed thereon or attached thereto.

The aerodynamic antenna ball body and the rearward projecting member, which has the combined functions of an inclined surface and tail, provide a design and appearance suitable for whimsical and/or business purposes.

### BRIEF DESCRIPTION OF THE DRAWINGS

Referring now to the drawings:

FIG. 1 is a perspective view of a preferred embodiment of the antenna ball body and rearward projecting member of the present invention.

FIG. 2 is a perspective view of the embodiment of FIG. 1 positioned on an antenna.

FIG. 3 is a perspective view of the preferred embodiment of FIG. 1 positioned on an antenna together with stoppers for controlling the flight path of the antenna ball body.

FIG. 4 is a planar view of a flexible stopper of the antenna ball assembly of FIG. 3.

FIG. 5 is a perspective view of the flexible stopper of FIG. 4 of the antenna ball assembly in use on an antenna of a vehicle.

FIG. 6 is a top view of the preferred embodiment of an antenna ball body and a rearward projecting member of FIG. 1.

FIG. 7 is a top view of a second preferred embodiment of an antenna ball body and a rearward projecting member of the antenna ball assembly of the invention.

FIG. 8 is a top view of a third preferred embodiment of an antenna ball body and a rearward projecting member of the antenna ball assembly of the invention.

FIG. 9 is a bottom view of the antenna ball body and the rearward projecting member of FIG. 8.

FIG. 10 is a front view of the antenna ball body and the rearward projecting member of FIG. 8.

FIG. 11 is a back view of the antenna ball body and the rearward projecting member of FIG. 8.

FIG. 12 is a side view of the antenna ball body and the rearward projecting member of FIG. 8, the opposite side view being a mirror image thereof.

FIG. 13 is a perspective view of a fourth preferred embodiment of an antenna ball body and a rearward projecting member of the present invention.

### DETAILED DESCRIPTION OF THE PREFERRED EMBODIMENTS

The present invention relates to an antenna ball assembly 10 which is displayed on an antenna and a method of use. The antenna ball assembly 10 may optionally include a design, advertisement or the like thereon. The antenna ball assembly 10 preferably is positioned on a car antenna such that the antenna ball body 20 moves up and down the car antenna as the car moves, thereby displaying the antenna ball body itself and any design or advertisement thereon or attached thereto.

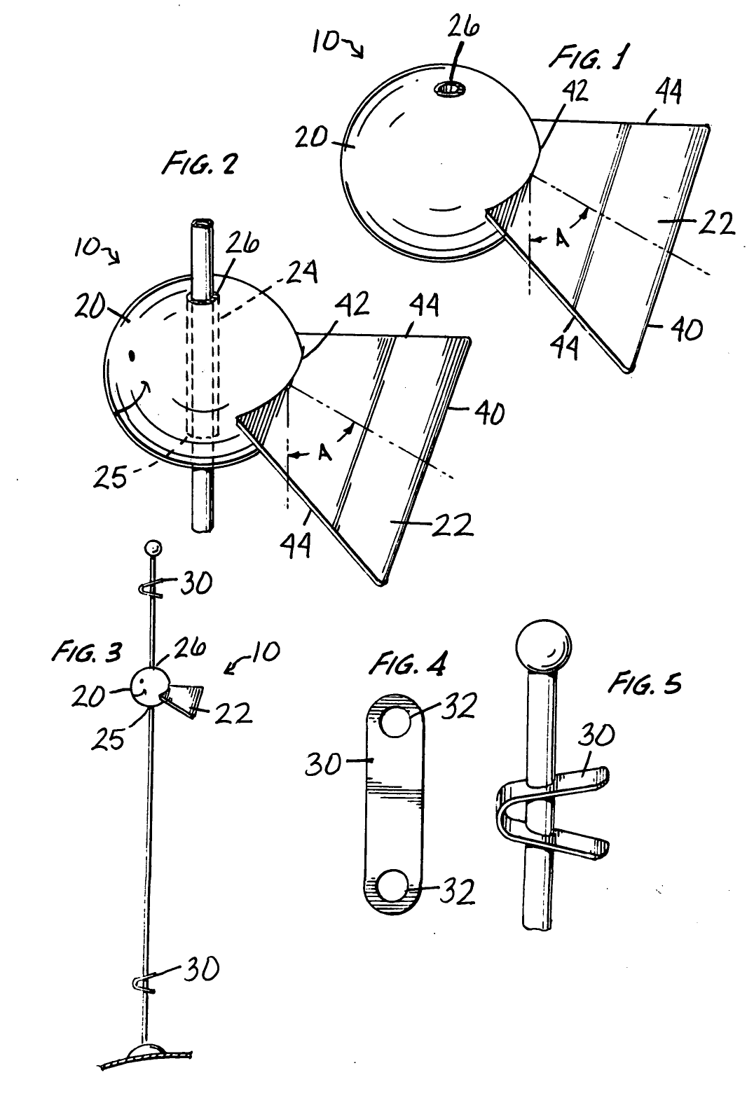

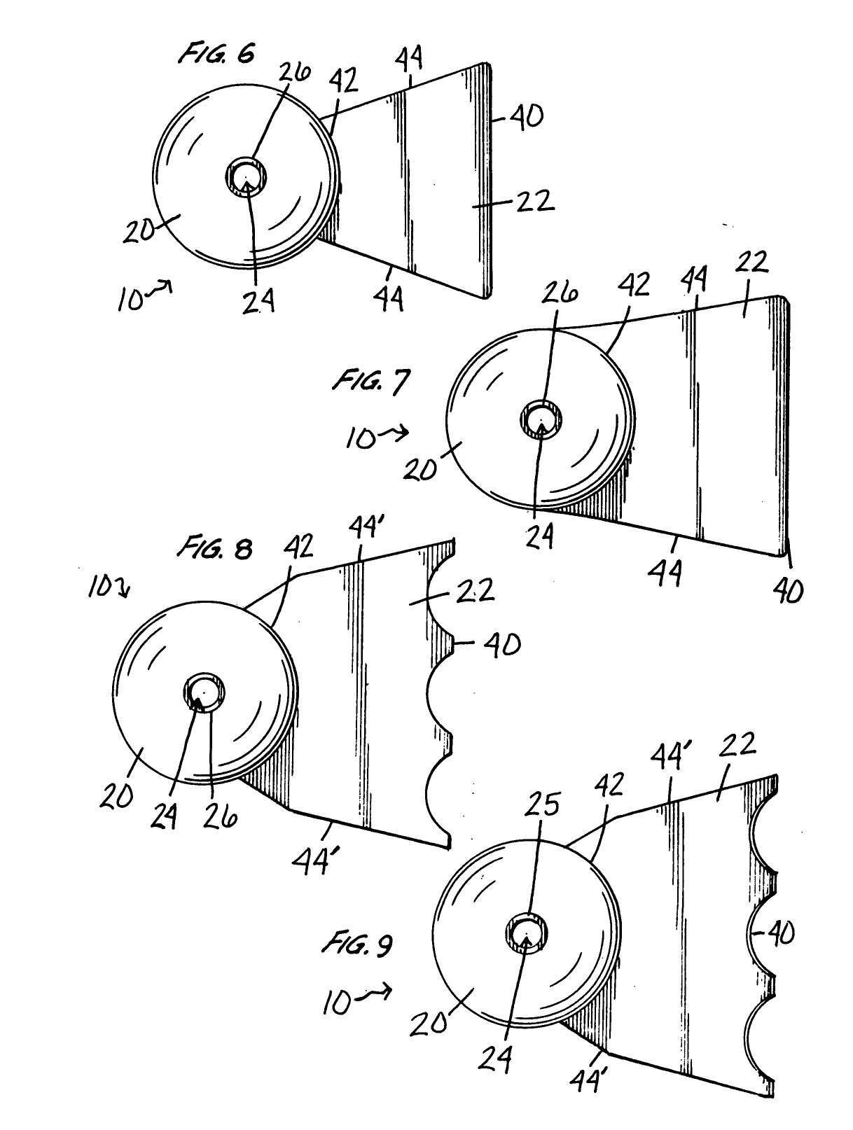

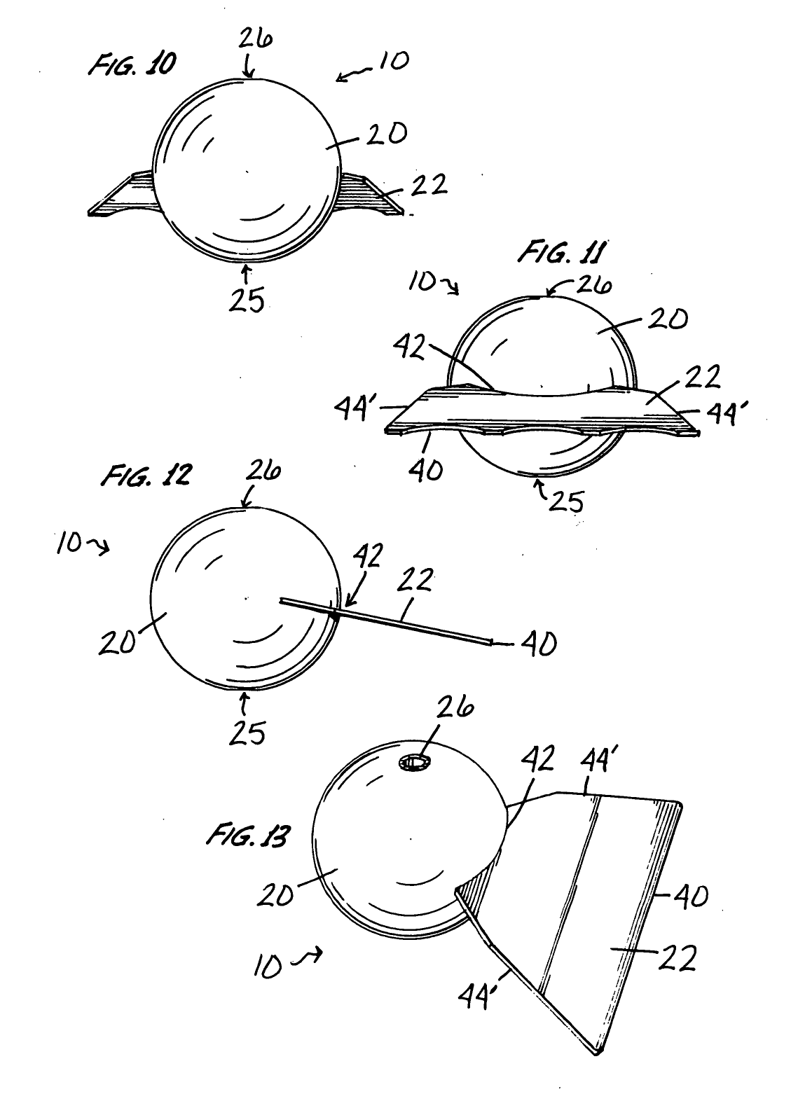

Referring to FIGS. 1-13, the antenna ball assembly 10 preferably comprises an antenna ball body 20 having a passage 24 therethrough, a rearward projecting member 22 attached to the antenna ball body 20 and preferably at least one flexible stopper 30. As shown in FIGS. 2 and 3, the antenna ball body 20 is placed on the antenna with the antenna passing through the passage 24 by passing through a first end 25 of the passage 24 and out a second end 26 of the passage 24. A first flexible stopper 30 is then placed on the car antenna to keep the antenna ball body 20 from coming off of the car antenna when in use, such as shown for example in FIGS. 3 and 5. A second flexible stopper 30 may be positioned at the bottom of a car antenna, such as shown for example in FIG. 3. The second stopper can provide a base for the ball body 20 so that the ball body does not get stuck on the bottom of the antenna. Some antennas have a tapered end or base that could inadvertently get wedged into or against the passage in the ball body making it difficult or preventing the ball body from moving upward on the antennae. Thus, the lower flexible stopper serves to decrease the amount of motion required before movement of the body along the antenna and maintains the body 20 in a lift position. The spacing or the distance between the upper and lower stoppers can be varied by the user so as to provide a predetermined motion of the ball body on the antenna.

The antenna ball body 20 preferably has a spherical or substantially spherical shape with a passage 24 therethrough and has a rearward projecting member 22 extending from the antenna ball body 20. In one preferred embodiment, the passage 24 is operatively positioned substantially through the center of the antenna ball body 20, such as shown for example in FIGS. 2 and 3. The passage 24 is of a size sufficient to fit over a car antenna or other rod-like extension on which the antenna ball body 20 is to be positioned.

While the antenna ball body 20 is preferably of a spherical or substantially spherical shape, the antenna ball body 20 may be any suitable shape which allows air to move around the body, particularly in an aerodynamic manner, including, but not limited to, oblong-shaped, blimp-shaped, egg-shaped, or the like.

The shape and angle A of the rearward projecting member 22 is essential to the function of the antenna ball assembly 10. Specifically, the rearward projecting member 22 has a shape, including a length and an extended width over at least a portion of the length, which in combination with angle A as to the rearward projecting member provides lift to the ball body 20 and allows the ball body 20 to move or fly up the car antenna as the car with the antenna moves.

The rearward projecting member 22 is structured to combine the functions of both an inclined surface, such as side extensions or wings, and a tail. The rearward projecting member 22 is attached to or may be integral with the body 20. The rearward projecting member 22 preferably operatively extends from the antenna ball body 20 at a location on the antenna ball body which is substantially perpendicular to the passage 24 at or near the horizontal circumference of the antenna ball body 20.

The rearward projecting member 22 has a free end 40, an attached end 42 which is connected to the antenna ball body 20, and side edges 44,44′. The rearward projecting member 22 may be of any suitable shape provided that the rearward projecting member 22 is at least wider at the free end 40 than at the attached end 42 connected to the antenna ball body 20 and at least the free end 40 of the rearward projecting member 22 is of a width greater than the width of the antenna ball body 20 at the location to which the rearward projecting member is attached. The attached end 42 has a width equal to or less than the width of the antenna ball body 20 at the location to which the attached end 42 is connected to the body to provide the best aerodynamics. This configuration of the rearward projecting member 22 provides lift to the antenna ball body 20 while keeping the antenna ball body 20 facing in a predetermined direction, such as into the wind, when the antenna ball assembly is on an antenna of a car in motion.

In one embodiment, the rearward projecting member 22 has side edges 44 which are substantially straight from the attached end 42 to the free end 40 thereof, such as shown for example in FIGS. 1-3 and 6-7. In another embodiment, the rearward projecting member 22 has side edges 44′ which have at least one angle between the attached end 42 and the free end 40 thereof, such as shown for example in FIGS. 8-13. The angle of the side edges 44′ may be any suitable angle which provides or aids in the desired air flow and/or provides a desired aesthetic to the rearward projecting member.

The free end 40 of the rearward projecting member 22 may be any suitable shape to assist in air flow, e.g. air flow around the antenna ball body 20 and/or in lift of the body 20 on the antenna, and/or to provide a desired aesthetic appeal. In one preferred embodiment, the free end 40 of the rearward projecting member 22 has a substantially straight edge, such as shown for example in FIGS. 1-3, 6-7 and 13. In another preferred embodiment, the free end 40 of the rearward projecting member 22 has a substantially scalloped edge, such as shown for example in FIGS. 8-12. In another embodiment, the free end 40 of the rearward projecting member 22 may be or include cut-outs of any other suitable shape including, but not limited to, square, triangular, diamond, arced or the like.

The rearward projecting member 22 preferably is structured in relation to the body 20 at an angle A, wherein angle A is less than 50°, preferably from about 20° to about 45°, and more preferably from about 25° to about 40°, and the angle is measured as between the rearward projecting member 22 and the passage 24 extending through the antenna ball body 20. Most preferably, the rearward projecting member 22 is positioned at an angle A along the width of the antenna ball body 20 from about 28° to about 38° or from about 30° to about 35°. This angle A is controlling in providing optimum function of the antenna ball body 20. This angle A allows the antenna ball body 20 to move or fly up the car antenna as the car with the antenna moves. With other angles, the antenna ball body 20 does not move smoothly up the antenna, and/or may not move completely to the top of the antenna where the stopper 30 is located, and/or may have difficulty in starting to move from the base of the antenna when the car moves.

The angle A may be measured from the upper or lower vertical axis of the passage 24 of the antenna ball body 20.

The flexible stopper 30 may be any suitable stopper. However, the flexible stopper 30 preferably has an oblong shape and has an opening 32 in each end, such as shown for example in FIG. 4. The flexible stopper 30 preferably flexes to form a substantially C-shape when in position on an antenna, such as shown for example in FIG. 5. This shape of the flexible stopper 30 is particularly advantageous in the functioning of the antenna ball assembly 10 by allowing continuous movement of the antenna ball body 20. Particularly, when the antenna ball body 20 moves up the antenna and comes in contact with the flexible stopper 30, the antenna ball body 20 has a bobbing motion against the stopper 30. As such, the antenna ball body 20 continues to move and does not remain rigid on the antenna, which provides a more eye-catching effect for any passersby. While the preferred embodiment of the flexible stopper 30 has been described, any suitable stopper, such as a soft body on the top of the antenna, may be used. Additionally, the stopper may be made of any suitable material including, but not limited to, rubber or plastic.

The weight of the antenna ball body 20 is not critical to the function of the antenna ball assembly 10. The antenna ball body 20 may preferably be made from a lightweight material such as, but not limited to, foam, rubber or plastic. The material providing the body only needs to have sufficient rigidity so as to maintain the selected angle A between the body and the rearward extending member.

The rearward projecting member 22 of the antenna ball body 20 may preferably be made from any suitable material such as, but not limited to, plastic, foam, rubber or the like which is sufficiently rigid to hold its shape and angle A.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. An antenna ball assembly comprising:
an antenna ball body of an aerodynamic shape having a passage extending through said body;
a rearward projecting member extending from said antenna ball body at an angle from about 20° to 50° or less from a vertical axis of said passage of said body, said rearward projecting member having an attached end connected to said antenna ball body, a free end, a first side edge and a second side edge, wherein at least said free end has a width greater than a width of said antenna ball body; and
at least one stopper;
wherein said passage is operatively positioned through said antenna ball body to maintain said rearward projecting member in a predetermined position when said body is positioned on an antenna,
wherein said angle and said width of said free end of said rearward projecting member controls movement of said antenna ball body on said antenna.

2. The antenna ball assembly of claim 1, wherein said angle is from about 25° to about 40°.

3. The antenna ball assembly of claim 1, wherein said attached end of said projecting member has a width equal to or less than said width of said antenna ball body.

4. The antenna ball assembly of claim 1, wherein said free end of said rearward projecting member is a substantially straight edge.

5. The antenna ball assembly of claim 1, wherein said free end of said rearward projecting member is a substantially scalloped edge.

6. The antenna ball assembly of claim 1, wherein said first side edge and said second side edge of said rearward projecting member are substantially straight.

7. The antenna ball assembly of claim 1, wherein each of said first side edge and said second side edge of said rearward projecting member has at least one angle formed therein between said free end and said attached end.

8. The antenna ball assembly of claim 1, wherein said angle is from about 30° to about 35°.

9. The antenna ball assembly of claim 1, wherein said at least one stopper is flexible and flat having a first end and a second end, wherein said first end and said second end each have an opening therein, wherein each opening is of a size sufficient to fit on said antenna.

10. The antenna ball assembly of claim 9, wherein said at least one stopper flexes to form a substantially C-shape when positioned on said antenna.

11. The antenna ball assembly of claim 1, wherein said assembly contains two of said at least one stopper, one for placement beneath said body and one for placement above said body.

12. The antenna ball assembly of claim 1, wherein said antenna ball body comprises foam, rubber or plastic.

13. The antenna ball assembly of claim 1, wherein said rearward projecting member comprises rubber, foam or plastic which is sufficiently rigid to maintain said angle and a predetermined shape of said rearward projecting member.

14. A method of displaying a novelty item having a design as a part thereof on an antenna comprising:
positioning the antenna ball assembly as claimed in claim 1 on an antenna, wherein said antenna ball assembly displays a design as a part of said body, or said rearward projecting member, or said body and said rearward projecting member.

15. The method of displaying a novelty item of claim 14, wherein said positioning of said antenna ball assembly on said antenna comprises:
positioning a first stopper at or near a base of said antenna;
positioning said antenna ball body on said antenna; and
positioning a second stopper at or near a top of said antenna, wherein said second stopper maintains said antenna ball body on said antenna.

16. The method of displaying a novelty item of claim 15, wherein said angle is from about 25° to about 40°.
